(19) United States
(12) Patent Application Publication
(10) Pub. No.: US 2012/0103735 A1
(43) Pub. Date: May 3, 2012

(54) BRAKING DEVICE AND METHOD FOR MANUFACTURING FRICTION MATERIAL

(75) Inventors: Kenji Abe, Aichi (JP); Hiroshi Isono, Shizuoka (JP); Yoshitomo Denou, Shizuoka (JP)

(73) Assignee: TOYOTA JIDOSHA KABUSHIKI KAISHA, Toyota-shi (JP)

(21) Appl. No.: 13/146,887

(22) PCT Filed: Jun. 15, 2009
(86) PCT No.: PCT/JP2009/060866

§ 371 Date: Jul. 28, 2011

(51) Int. Cl. F16D 69/00; F16D 65/02

(52) U.S. Cl. 188/73.1

(57) ABSTRACT

There is provided a braking device including a pad having a friction surface, and a disc having a friction surface sliding on the friction surface. The pad includes, in the friction surface, a plurality of hard particles tilted in the opposite direction to a direction in which the friction surface slides on the friction surface, and the disc includes, in the friction surface, a plurality of hard particles tilted in the direction in which the friction surface slides on the friction surface. Thereby, mutually pressing forces between the hard particles are increased. Additionally, the mutually pressing forces between the hard particles are increased, and consequently the distance between the friction surfaces is shortened. Therefore, a higher frictional force can be obtained.

### TECHNICAL FIELD

The present invention relates to a braking device and a method for manufacturing a friction material, and particularly, to a braking device including a pair of friction materials having a friction surface, and a method for manufacturing a friction material having a friction surface.

### BACKGROUND ART

A braking device consisting of a pad and a rotor (disc) of a conventional brake for an automobile is a combination of a relatively hard component and a relatively soft component. Therefore, the conventional braking device has a problem in that the effect of the brake is poor or either of the hard and soft components is apt to wear out. For example, in a braking device in which a non-steel pad consisting of a soft resin-based component, and a harder cast-iron rotor are combined together, and a frictional force is generated by adhesion friction, there is a problem in that the effect of the brake is poor. Additionally, in a braking device in which a low steel pad consisting of hard steel fibers, and a softer cast-iron rotor are combined together, and a frictional force is generated by abrasive friction, there is a problem in that there is a lot of wear on a rotor.

Thus, for example, Patent Literature 1 discloses a friction material set which has a friction material and a mating material and which generates a braking force, using a frictional force generated between the friction material and the mating material. The friction material has a fiber base material, a friction regulator, and a binder of an organic substance. The friction material contains SiC fibers as the friction regulator. 80 volume % or more of the SiC fibers are arranged at an angle of 40° to 140° with respect to the mating material. The mating material has a cermet layer on the surface thereof.

### CITATION LIST

### Patent Literature

Patent Literature 1: JP-A-2007-39556

### SUMMARY OF INVENTION

### Technical Problem

In the braking device in which hard materials are arranged on both a friction material and a mating material as described above, there is an advantage that wear is very slight on both the friction material and the mating material. However, in the braking device in which hard materials are arranged on both the friction material and the mating material as described above, the frictional force (coefficient of friction) between the friction material and the mating material is not necessarily made high.

The invention has been made in consideration of such circumstances, and the object thereof is to provide a braking device and a method for manufacturing a friction material which can obtain a higher frictional force.

### Solution to Problem

The invention provides a braking device including a first friction material having a first friction surface, and a second friction material having a second friction surface which moves with respect to the first friction surface. The first friction material includes, in the first friction surface, a plurality of projections tilted in the opposite direction to a direction in which the second friction surface moves with respect to the first friction surface. The second friction material includes, in the second friction surface, a plurality of projections tilted in the direction in which the second friction surface moves with respect to the first friction surface.

According to this configuration, in a braking device including a first friction material having a first friction surface, and a second friction material having a second friction surface which moves with respect to the first friction surface, the first friction material includes, in the first friction surface, a plurality of projections tilted in the opposite direction to a direction in which the second friction surface moves with respect to the first friction surface, and the second friction material includes, in the second friction surface, a plurality of projections tilted in the direction in which the second friction surface moves with respect to the first friction surface. Therefore, the mutually pressing forces between the projections are increased. Additionally, as a consequence of the increase of the mutually pressing forces between the projections, the distance between the friction surfaces is shortened. Therefore, a higher frictional force can be obtained.

In this case, it is preferable that, as the second friction material rotates, the second friction surface moves with respect to the first friction surface.

According to this configuration, the braking device of the invention can be applied to an automobile, for example, using the first friction material as a brake pad and using the second friction material as a brake disc or a brake drum.

Additionally, the invention provides a method for manufacturing a friction material having a friction surface which moves relative to the other friction material, and including a plurality of projections tilted in the direction of movement relative to the other friction material in the frictional surface. The method includes the steps of arranging a plurality of rod-shaped hard members within a frame in a dispersed manner such that the longitudinal direction thereof is oriented to one direction; fixing the hard members arranged within the frame by a connection material, and exposing the hard members fixed by the connection material to form the friction surface such that the longitudinal direction of the hard members becomes a direction tilted in the direction of movement relative to the other friction material.

According to this configuration, a plurality of rod-shaped hard members is arranged within a frame in a dispersed manner such that the longitudinal direction thereof is oriented to one direction, the hard members arranged within the frame are fixed by a connection material, and the hard members fixed by the connection material are exposed to form the friction surface such that the longitudinal direction of the hard members becomes a direction tilted in the direction of movement relative to the other friction material. Therefore, it is possible to easily manufacture the friction material which has the friction surface which moves relative to the other friction material and which includes, in the friction surface, a plurality of projections tilted in the direction of movement relative to the other friction material to generate a high frictional force.

In this case, preferably, in the arranging of the plurality of rod-shaped hard members in a dispersed manner within the frame such that the longitudinal direction thereof is oriented to one direction, the hard members within the frame are pressurized under weightlessness and are thereby arranged such that the longitudinal direction of the hard members is oriented to one direction.

According to this configuration, in the arranging of the plurality of rod-shaped hard members in a dispersed manner within the frame such that the longitudinal direction thereof is oriented to one direction, the hard members within the frame are pressurized under weightlessness and are thereby arranged such that the longitudinal direction of the hard members is oriented to one direction. Therefore, it becomes easy to arrange the plurality of rod-shaped hard members in a dispersed manner within the frame such that the longitudinal direction thereof is oriented to one direction.

Additionally, preferably, in the arranging of the plurality of rod-shaped hard members in a dispersed manner within the frame such that the longitudinal direction thereof is oriented to one direction, a magnetic force is applied to the hard members within the frame, and thereby, the hard members are arranged such that the longitudinal direction thereof is oriented to one direction.

According to this configuration, in the arranging of the plurality of rod-shaped hard members in a dispersed manner within the frame such that the longitudinal direction thereof is oriented to one direction, a magnetic force is applied to the hard members within the frame, and thereby, the hard members are arranged such that the longitudinal direction thereof is oriented to one direction. Therefore, it becomes easy to arrange the plurality of rod-shaped hard members in a dispersed manner within the frame such that the longitudinal direction thereof is oriented to one direction.

### Advantageous Effects of Invention

According to the braking device of the invention, a higher frictional force can be obtained. Additionally, according to the method for manufacturing a friction material of the invention, a friction material which can obtain a higher frictional force can be more easily manufactured.

### BRIEF DESCRIPTION OF DRAWINGS

FIG. 1 is a perspective view showing a pad and a disc related to a first embodiment.

FIG. 2 is a side view showing the pad and the disc related to the first embodiment.

FIG. 3 is an enlarged view of a part A of FIG. 2 related to the first embodiment.

FIG. 4 is an enlarged view of the part A of FIG. 2 related to a second embodiment.

FIG. 5 is an enlarged view of the part A of FIG. 2 related to a third embodiment.

FIG. 6 is an enlarged view of the part A of FIG. 2 related to a fourth embodiment.

FIG. 7 is a side view showing a pad and a disc related to a fifth embodiment.

FIGS. 8A to 8C are views showing the process for manufacturing a pad related to a sixth embodiment.

FIG. 9 is a view showing the process for manufacturing a pad related to a seventh embodiment.

### DESCRIPTION OF EMBODIMENTS

Hereinafter, a braking device related to embodiments of the invention will be described with reference to the drawings.

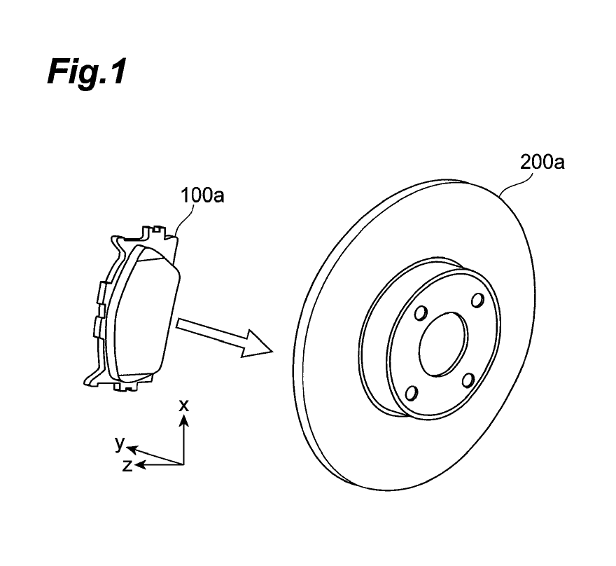

In a first embodiment of the invention, the braking device related to the invention is applied to a disc brake of an automobile. As shown in FIG. 1, the disc brake generates a frictional force as a pad 100a is pressed against a disc 200a which rotates.

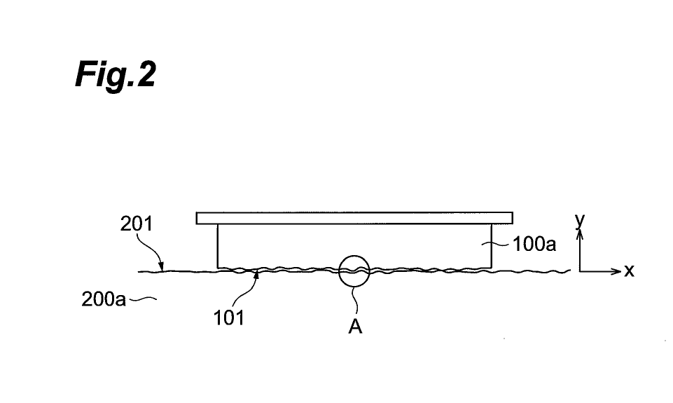

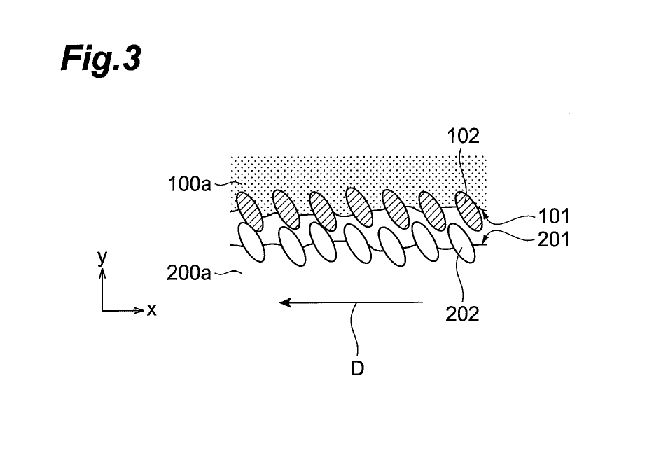

As shown in FIG. 2, which is a side view from a z-direction of FIG. 1, a friction surface 101 of the pad 100a and a friction surface 201 of the disc 200a abut on each other. As shown in FIG. 3 which is an enlarged view of a part A of FIG. 2, in the present embodiment, a plurality of plate-shaped or rod-shaped hard particles 102 or 202 is elastically supported by the friction surfaces 101 or 201. The hard particles 102 of the friction surface 101 of the pad 100a are supported such that the longitudinal direction thereof is tilted in the opposite direction to a direction (when an automobile is moving forward) in which the friction surface 201 of the disc 200a slides on the friction surface 101 of the pad 100a. On the other hand, the hard particles 202 of the friction surface 201 of the disc 200a are supported such that the longitudinal direction thereof is tilted in a direction in which the friction surface 201 of the disc 200a slides on the friction surface 101 of the pad 100a.

The longitudinal length of the hard particles 102 or 202 is about 10 to 40 μm, and the length of the hard particles in the width direction is 5 to 20 μm. The hard particles 102 or 202 are made of ceramics, such as Si₃N₄, Al₂O₃, and ZrO₂. Additionally, the hard particles 102 or 202 have hardness such that the hard particles are not worn out during braking, or preferably have a Mohs hardness of 9 or more. Additionally, the hard particles 102 or 202 are made of the same kind of material, or are preferably made of a material having the same Mohs hardness.

Hereinafter, the operation of the braking device of the present embodiment will be described. As shown in the above Patent Literature 1, in a case where the hard members elastically supported by the friction surface are pressed against each other, thereby generating a frictional force, there is a concern that the hard members may vibrate, and the distance between the friction surfaces may not be stabilized, and the friction surfaces may be separated from each other on average. Therefore, in the braking device like the above Patent Literature 1, the frictional force is unstable and low.

The measures for the above problem include increasing the mutually pressing forces between the hard members, and causing the hard members not to vibrate easily.

Thus, in the present embodiment, in a braking device including a pad 100a having a friction surface 101, and a disc 200a having a friction surface 201 sliding on the friction surface 101, the pad 100a includes, in the friction surface 101, a plurality of hard particles 102 tilted in the opposite direction to a direction in which the friction surface 201 slides on the friction surface 101, and the disc 200a includes, in the friction surface 201, a plurality of hard particles 202 tilted in the direction in which the friction surface 201 slides on the friction surface 101. Therefore, the mutually pressing forces between the hard particles 102 and 202 increase. Additionally, as a consequence of the increase of the mutually pressing forces between the hard particles 102 and 202, the distance between the friction surfaces 101 and 201 is shortened. Therefore, a higher frictional force can be obtained.

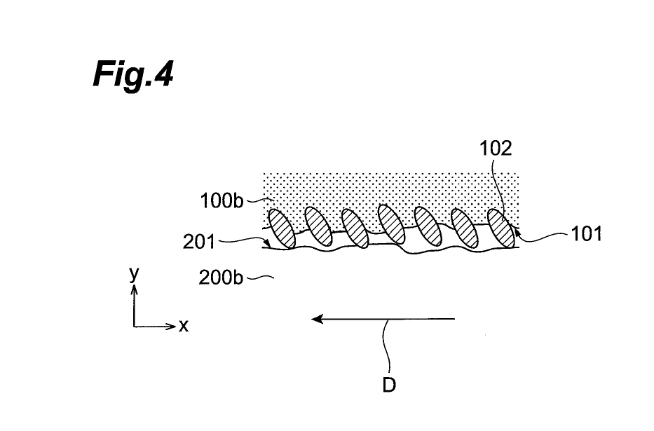

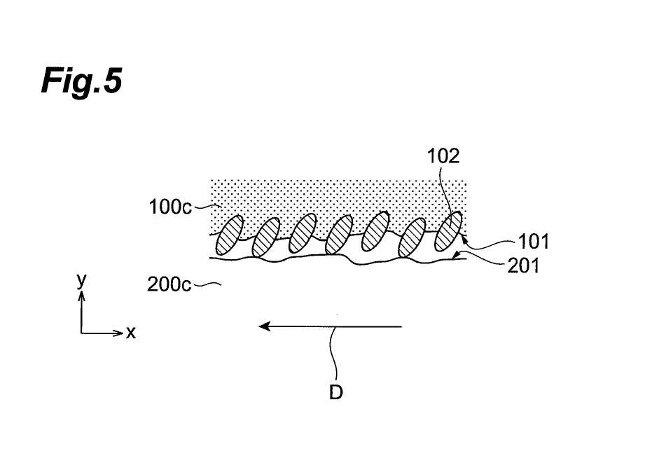

In addition, a configuration in which the hard particles 102 tilted in the direction opposite to the sliding direction of the friction surface 201 of the disc 200b are arranged only at a pad 100b is also considered like the pad 100b and a disc 200b of a second embodiment shown in FIG. 4. Additionally, a configuration in which the hard particles 102 tilted in the sliding direction of the friction surface 201 of the disc 200c are arranged only at a pad 100c is also considered like the pad 100c and a disc 200c of a third embodiment shown in FIG. 5.

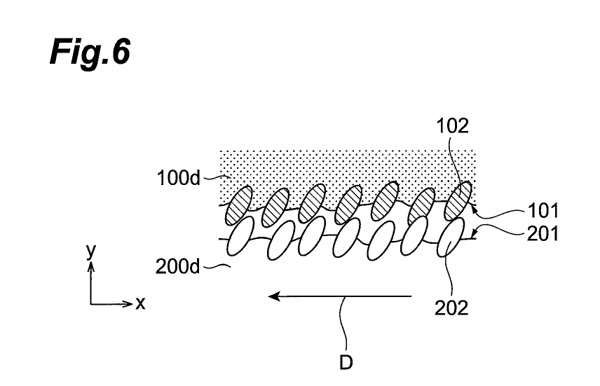

Moreover, a configuration in which a plurality of hard particles 102 tilted in a direction in which the friction surface 201 slides is arranged in the friction surface 101 of a pad 100d, and a plurality of hard particles 202 tilted in the opposite direction to the direction in which the friction surface 201 slides is arranged in a friction surface 201 of a disc 200d is also considered like the pad 100d and the disc 200d of a fourth embodiment shown in FIG. 6.

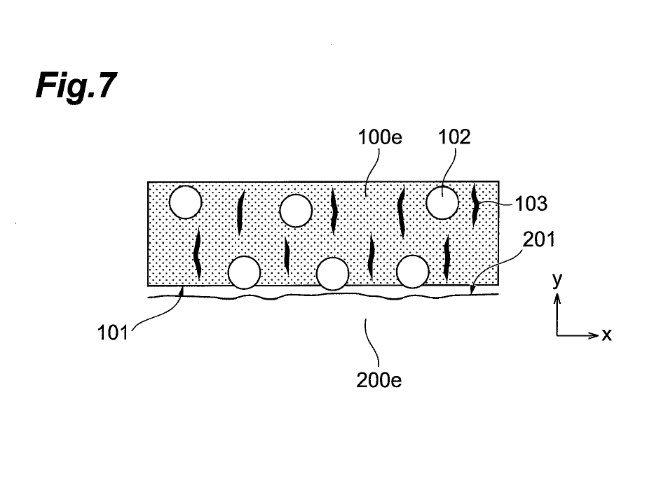

Hereinafter, a fifth embodiment of the invention will be described. As shown in FIG. 7, as for a pad 100e and a disc 200e of the present embodiment, in the pad 100e, a plurality of shape memory objects 103 made of metal-based fibers is embedded as well as a plurality of hard particles 102 being embedded. The shape memory objects 103 are made of a material which reacts and restores itself when a slightly higher temperature is exceeded in a temperature zone when the braking device is used. Specifically, the shape memory objects 103 are made of a material which reacts and restores itself when 100 to 200° C. is exceeded at a part with a depth of 1 mm from the friction surface 101 or 201.

Hereinafter, the working effects of the braking device of the present embodiment will be described. As shown in the above Patent Literature 1, in a case where the hard members elastically supported by the friction surface are pressed against each other to generate a frictional force, an elastic body which supports the hard members is made of a slightly soft material in order for the hard members to follow mutually irregular shapes. However, the strength may be insufficient when supporting the hard members only with the soft material. Particularly, if a large load is applied to a portion of the friction surface due to circumstances, such as foreign matter, such as sand, entering the friction surface temporarily, the portion will be plastically deformed and dented. As a result, the distance between the friction surfaces becomes large, and the frictional force declines.

Thus, in the present embodiment, even if the friction surface 101 is plastically deformed by embedding the shape memory objects 103 in the pad 100e, the friction surface returns to its original shape. Particularly, since the shape memory objects 103 are made of a material which reacts and restores itself when a slightly higher temperature is exceeded in a temperature zone when the braking device is used, the shape of the shape memory objects 103 restores itself particularly during the braking when temperature increases to a temperature slightly higher than a temperature at which the function of the brake is required. Therefore, when the function of the brake is required, the distance between the pad 100e and the disc 100e is restored, and the frictional force returns.

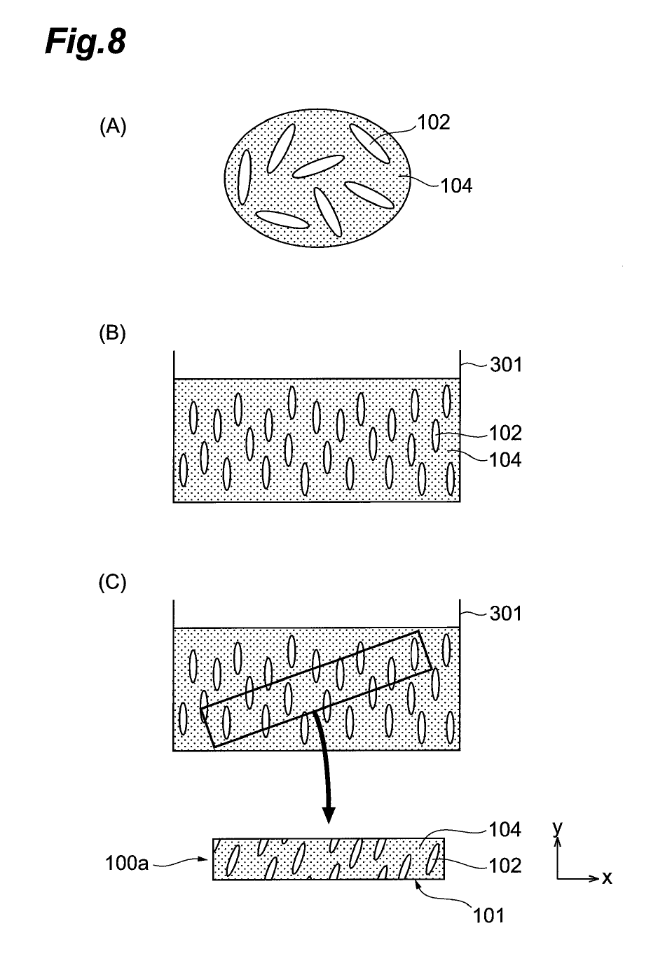

Hereinafter, a sixth embodiment of the invention will be described. When the pad 100a or the like of the above first embodiment is manufactured, as shown in FIG. 8A, the rod-shaped hard particles 102 are uniformly mixed with, for example, resin 104 which is an elastic body which is liquefied with a certain viscosity at high temperature, or a powdered elastic body.

As shown in FIG. 8B, a mixture of the hard particles 102 and the resin 104 is put into a mold 301, and is pressurized in one direction in a weightless state, for example, by a method of rotating the mold 301. Thereby, the longitudinal direction of the hard particles 102 is oriented to one direction. The mixture of the hard particles 102 and the resin 104 in which the longitudinal direction of the hard particles 102 is orientated to one direction is cured by being gently sintered or being cooled. When the mixture of the quality particles 102 and the resin 104 is put into the mold 301, the mixture of the quality particles 102 and the resin 104 may be made to flow into the mold 301 while vibration is imparted. Thereby, the longitudinal direction of the hard particles 102 can be aligned.

As shown in FIG. 8C, the cured resin 104 containing the hard particles 102 is cut out such that the longitudinal direction of the hard particles 102 is tilted in a desired direction with respect to the friction surface 101. In this case, it is efficient that a plurality of the pads 100a is cut out from the mold 301.

In the present embodiment, a plurality of rod-shaped hard particles 102 is arranged in a dispersed manner within the mold 301 such that the longitudinal direction thereof is orientated to one direction, the hard particles 102 arranged within the mold 301 are fixed with the resin 104, and the hard particles 102 fixed with the resin 104 are exposed to form the friction surface 101 such that the longitudinal direction of the hard particles 102 becomes a direction tilted in the direction of movement relative to the disc 200a. Therefore, it is possible to easily manufacture the pad 100a which has the friction surface 101 which moves relative to the disc 200a and which includes, in the friction surface 101, a plurality of projections tilted in the direction of movement relative to the disc 200a to generate a high frictional force.

Additionally, according to the present embodiment, in the process of arranging a plurality of rod-shaped hard particles 102 in a dispersed manner such that the longitudinal direction thereof is oriented to one direction within the mold 301, the hard particles 102 within the mold 301 are pressurized under weightlessness, and are thereby arranged such that the longitudinal direction of the hard particles 102 is oriented to one direction. Therefore, it becomes easy to arrange the plurality of rod-shaped hard particles 102 in a dispersed manner such that the longitudinal direction thereof is oriented to one direction within the mold 301.

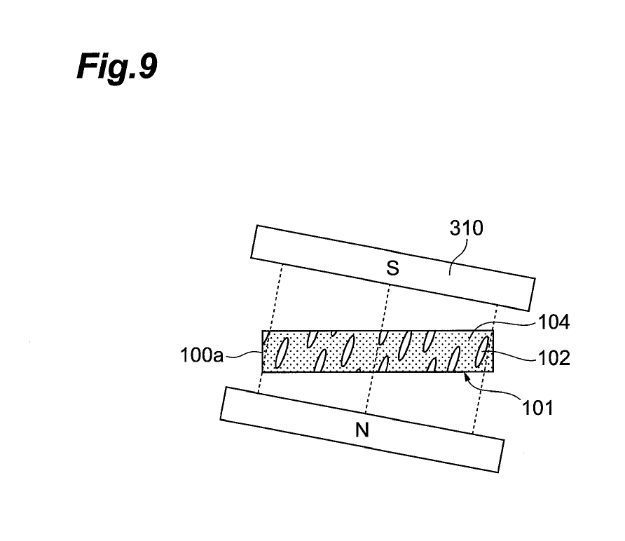

In addition, as shown in a seventh embodiment of the invention shown in FIG. 9, in a case where the hard particles 102 are metal-based, a magnetic force may be applied to the hard particles 102 within the mold 301 by a magnet 310, and thereby, the hard particles 102 may be arranged such that the longitudinal direction thereof is oriented to one direction. Thereby, it becomes easy to arrange the plurality of rod-shaped hard particles 102 in a dispersed manner such that the longitudinal direction thereof is oriented to one direction.

Although the embodiments of the invention have been described above, the invention is not limited to the above embodiments, and various modifications thereof can be made.

### INDUSTRIAL APPLICABILITY

The invention can provide a braking device which can obtain a higher frictional force. Additionally, the invention can provide a method for manufacturing a friction material which can more easily manufacture a friction material which can obtain a higher frictional force.

### REFERENCE SIGNS LIST

100a to 100e: PAD
101: FRICTION SURFACE
102: HARD PARTICLE
103: SHAPE MEMORY OBJECT
104: RESIN
200a to 200e: DISC
201: FRICTION SURFACE
202: HARD PARTICLE
301: CONTAINER
310: MAGNET

1. A braking device comprising:
a first friction material having a first friction surface, and
a second friction material having a second friction surface which moves with respect to the first friction surface,
wherein the first friction material includes, in the first friction surface, a plurality of projections tilted in the opposite direction to a direction in which the second friction surface moves with respect to the first friction surface, and
wherein the second friction material includes, in the second friction surface, a plurality of projections tilted in the direction in which the second friction surface moves with respect to the first friction surface.

2. The braking device according to claim 1,
wherein as the second friction material rotates, the second friction surface moves with respect to the first friction surface.

3. (canceled)

4. (canceled)

5. (canceled)
